(19) United States
(12) Patent Application Publication
(10) Pub. No.: US 2016/0214872 A1
(43) Pub. Date: Jul. 28, 2016

(54) ULTRAVIOLET IRRADIATION APPARATUS

(71) Applicant: KABUSHIKI KAISHA TOSHIBA, Tokyo (JP)

(72) Inventors: Shinji KOBAYASHI, Machida Tokyo (JP); Norimitsu ABE, Kawasaki Kanagawa (JP); Takeshi IDE, Kunitachi Tokyo (JP); Akihiko SHIROTA, Hachioji Tokyo (JP); Kenji TAKEUCHI, Fuchu Tokyo (JP)

(73) Assignee: Kabushiki Kaisha Toshiba, Tokyo (JP)

(21) Appl. No.: 14/916,549

(22) PCT Filed: Mar. 12, 2014
(86) PCT No.: PCT/JP2014/056459

§ 371 Date: Mar. 3, 2016

(30) Foreign Application Priority Data
Sep. 11, 2013 (JP) 2013-188749

(51) Int. Cl. C02F 1/32; C02F 1/52; C02F 1/28; C02F 1/76

(52) U.S. Cl. CPC C02F 1/32; C02F 1/76; C02F 1/52; C02F 1/283; C02F 2103/06

(57) ABSTRACT

According to an embodiment, an ultraviolet (UV) irradiation apparatus includes a treatment tank, a UV irradiation member, a UV sensor, and a sludge discharge unit. The sludge discharge unit, is connected to a discharge hole provided at a position lower than a horizontal plane passing through the UV sensor, and is provided to discharge, to outside of the treatment tank, through the discharge hole, sludge that accumulates inside the treatment tank when the treated water sasses through the inside of the treatment tank.

### FIELD

Embodiments of the present invention relate to an ultraviolet irradiation apparatus.

### BACKGROUND

Conventionally, there has been known an ultraviolet (UV) irradiation apparatus that includes: a treatment tank through which treated water passes; a UV irradiation member that is provided inside the treatment tank and irradiates treated water passing through the inside of the treatment tank with UV light; and a UV sensor that is provided inside the treatment tank and measures a dose of UV irradiation from the UV irradiation member (refer to, for example, Patent Literature 1).

### CITATION LIST

### Patent Literature

Patent Literature 1: Japanese Laid-open Patent Application Publication No. 2002-263645

### SUMMARY OF THE INVENTION

### Problem to be Solved by the Invention

In such a conventional UV irradiation apparatus as described above, sludge (mud, sediments, or suspended solids) in treated water may accumulate inside (in a bottom part of) the treatment tank when the treated water passes through the inside of the treatment tank. When such accumulation has occurred, sludge may attach to a UV light receiving surface of the UV sensor as a result of accumulation of sludge between the UV sensor and the UV irradiation member. Consequently, the accuracy of UV irradiation dose measurement performed by the UV sensor is possibly impaired.

The present invention is aimed at eliminating the above-described inconvenience, and it is one object of the present invention to provide a UV irradiation apparatus in which accumulation of sludge between a UV sensor and a UV irradiation member can be prevented.

### Means for Solving Problem

An ultraviolet (UV) irradiation apparatus according to an embodiment comprises a treatment tank, a UV irradiation member, a UV sensor, and a sludge discharge unit. The treatment tank comprises a water supply opening to supply therethrough treated water to be further treated and a water drainage opening to drain therethrough the treated water. The UV irradiation member is provided inside the treatment tank and irradiates the treated water with UV light when the treated water passes through inside of the treatment tank. The UV sensor is provided inside the treatment tank and measures a dose of UV irradiation from the UV irradiation member. The sludge discharge unit is connected to a discharge hole provided at a position lower than a horizontal plane passing through the UV sensor and is provided to discharge, to outside of the treatment tank, through the discharge hole, sludge that accumulates inside the treatment tank when the treated water passes through the inside of the treatment tank.

### BRIEF DESCRIPTION OF DRAWINGS

FIG. 1 is a flowchart illustrating a procedure of tap water treatment using a tap water treatment system including an ultraviolet (UV) irradiation apparatus according to a first embodiment.

FIG. 2 is a perspective view illustrating the outside appearance of the UV irradiation apparatus according to the first embodiment.

FIG. 3 is a cross-sectional view of the UV irradiation apparatus illustrated in FIG. 2, taken along an X-Z plane.

FIG. 4 is a cross-sectional view of the UV irradiation apparatus illustrated in FIG. 2, taken along a Y-Z plane.

FIG. 5 is a cross-sectional view illustrating a UV irradiation apparatus according to a modification of the first embodiment.

FIG. 6 is a perspective view illustrating the outside appearance of a UV irradiation apparatus according to a second embodiment.

FIG. 7 is a cross-sectional view of the UV irradiation apparatus illustrated in FIG. 6, taken along an X-Z plane.

FIG. 8 is a cross-sectional view of the UV irradiation apparatus illustrated in FIG. 6, taken along a Y-Z plane.

### DETAILED DESCRIPTION

Based on the drawings, the following describes embodiments.

### First Embodiment

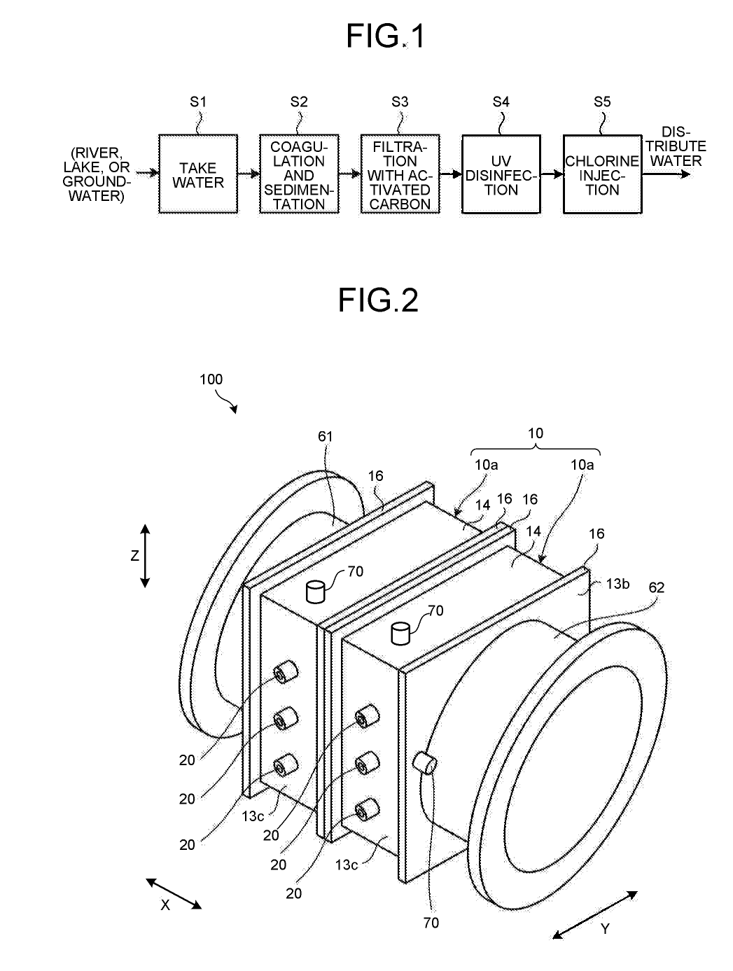

First, one example of a tap water treatment procedure to be performed by a tap water treatment system 1000 including an ultraviolet (UV) irradiation apparatus 100 according to a first embodiment (refer to FIG. 2 to FIG. 4) is described with reference to FIG. 1.

In this tap water treatment system 1000, at Step S1, raw water is taken from a river, a lake, groundwater, or the like, as illustrated in FIG. 1. Step S2 then follows this step.

Subsequently, at Step S2, raw water taken in through the above process at Step S1 is introduced into a coagulation sedimentation tank, and a coagulant is added to the introduced raw water. Step S3 then follows this step.

Subsequently, at Step S3, supernatant water in the raw water subjected to the above process (a coagulation sedimentation process) at Step S2 is transported into an activated-carbon filtration tank, and foreign substances are removed from the supernatant water. Step S4 then follows this step.

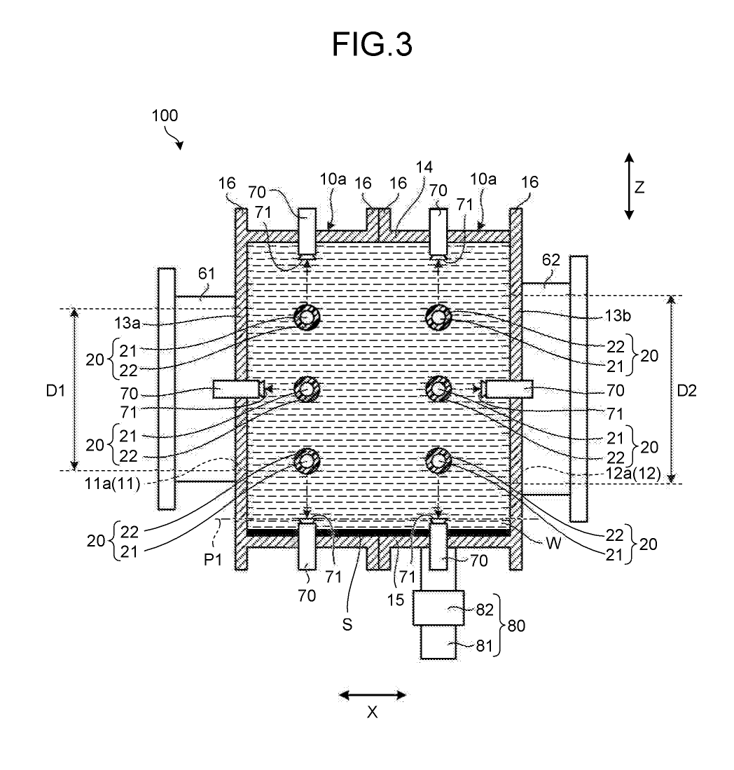

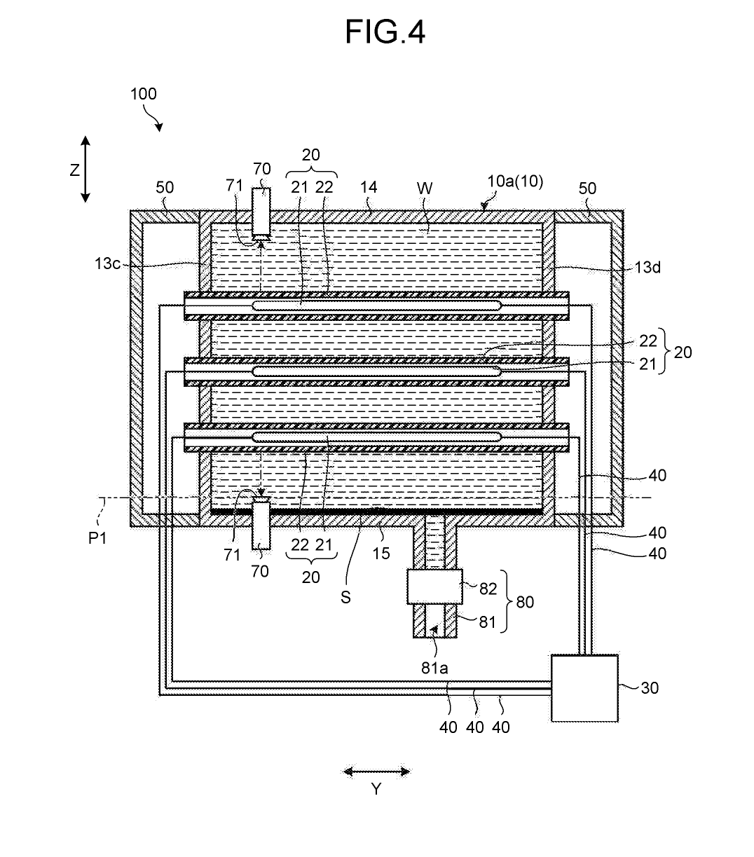

Subsequently, at Step S4, the filtered water subjected to the above process (an activated-carbon filtration process) at Step S3 (treated water W; refer to FIG. 3 and FIG. 4) is transported into the UV irradiation apparatus 100, and sterilization, disinfection, decoloring, and the like using UV light are performed on the treated water W. Step S5 then follows this step.

Subsequently, at Step S5, the treated water W subjected to the above process (a UV disinfection process) at Step S4 (UV disinfection treated water W) is transported into a chlorine injection tank, and chlorine is injected into the UV disinfection treated water W. The treated water W subjected to the process (a chlorine injection process) at Step S5 is distributed to homes and offices.

Next, one example of a configuration of the UV irradiation apparatus 100 according to the first embodiment is described with reference to FIG. 2 to FIG. 4.

As illustrated in FIG. 2 to FIG. 4, the UV irradiation apparatus 100 includes a treatment tank (a reaction tank, or reactor) 10 to temporarily store the treated water W to be further treated (refer to FIG. 3 and FIG. 4), and a plurality of (in the first embodiment, six) UV irradiation members 20 to irradiate the treated water W stored inside the treatment tank 10 with UV light. The treatment tank 10 has a hollow rectangular parallelepiped shape (box shape) that is dividable into two tank parts 10a. FIG. 3 is a cross-sectional view of the UV irradiation apparatus 100 illustrated in FIG. 2, taken along an X-Z plane that passes through UV monitors 70 to be described later. FIG. 4 is another cross-sectional view of the UV irradiation apparatus 100 illustrated in FIG. 2, taken along a Y-Z plane that passes through a sludge discharge unit 80 (not illustrated in FIG. 2) to be described later.

As illustrated in FIG. 3, the treatment tank 10 includes a water supply opening 11 to supply the treated water W therethrough, and a water drainage opening 12 to drain the treated water W therethrough after the treatment is performed thereon. The water supply opening 11 and the water drainage opening 12 are provided in opposite surface parts of the treatment tank 10 (side surface parts 13a and 13b facing each other in a certain direction (the X direction) within a horizontal plane). Specifically, the water supply opening 11 is provided around the central part of the side surface part 13a of the tank part 10a, which is positioned in the left-hand side of the illustration in FIG. 3. The water drainage opening 12 is provided around the central part of the side surface part 13b of the tank part 10a, which is positioned in the right-hand side of the illustration in FIG. 3.

Additionally, ribs 16 to prevent the treatment tank 10 from being deformed with an increase in pressure inside the treatment tank 10 are provided to the treatment tank 10. These ribs 16 are provided on surface parts of the treatment tank 10 (the tank parts 10a) other than the side surface parts 13a and 13b (i.e., on side surface parts 13c and 13d, an upper surface part 14, and a lower surface part 15). Specifically, the ribs 16 are provided at the left end of the tank part 10a positioned in the left-hand side of the illustration in FIG. 3, at the right end of the tank part 10a positioned in the right-hand side of the illustration in FIG. 3, and at the boundary portions of these two tank parts 10a (the central portion of the treatment tank 10 as a whole in the left-to-right direction thereof (the X-direction)).

As illustrated in FIG. 2 to FIG. 4, the UV irradiation members 20 are arranged apart from one another. Specifically, as illustrated in FIG. 3, six UV irradiation members 20 are provided inside the treatment tank 10 apart from one another in the vertical direction (the Z direction) and in the left-to-right direction (the X direction). More specifically, the six UV irradiation members 20 are arranged so that, while three of them are aligned in the Z direction, two of them are aligned in the X direction.

As illustrated in FIG. 4, each of the UV irradiation members 20 is provided so as to linearly extend in a direction (the Y direction) perpendicular to the X direction within a horizontal plane. Each of the UV irradiation members 20 includes a UV lamp 21 that irradiates a target with UV light, and a tubular protective tube 22 covering the UV lamp 21. The protective tube 22 is made of a material that transmits UV light. For example, the protective tube 22 is made of a transparent dielectric material such as silica glass.

The opposite ends of the respective UV lamps 21 in the Y direction are connected via wiring 40 to an electronic ballast 30 provided outside the treatment tank 10. The electronic ballast 30 is a piece of equipment that supplies power to the UV lamps 21 and maintains the stability of electrical discharge. The opposite ends of the respective protective tubes 22 in the Y direction are provided so as to project outward from the side surface parts 13c and 13d of the treatment tank 10. Furthermore, portions of the protective tubes 22 that project from the treatment tank 10 are covered with covering members 50 attached to the respective opposite ends in the Y direction of the treatment tank 10. Each of the covering members 50 has functions such as a light blocking function, an electric shock prevention function, an electromagnetic shield function, and a dew condensation prevention function. Illustration of the covering members 50 is omitted from FIG. 2.

Here, in the first embodiment, the water supply opening 11 and the water drainage opening 12, which are provided in the respective side surface parts 13a and 13b of the treatment tank 10, have different inner diameters. Specifically, as illustrated in FIG. 3, the inner diameter D1 of the water supply opening 11 is smaller than the inner diameter D2 of the water drainage opening 12. As illustrated in FIG. 2 and FIG. 3, a water supply port 61 and a water drainage port 62 in cylindrical shapes linearly extending in the X direction are connected to the water supply opening 11 and the water drainage opening 12, respectively. This structure causes the treated water W to pass through the inside of the treatment tank 10 from the water supply opening 11 (the water supply port 61) toward the water drainage opening 12 (the water drainage port 62) (in the X direction).

Furthermore, in the first embodiment, UV monitors 70 and the sludge discharge unit (drain port) 80 are provided in the lower surface part 15 of the treatment tank 10 (the tank parts 10a). Specifically, the respective UV monitors 70 are provided in parts of the lower surface part 15 that correspond to the respective two tank parts 10a included in the treatment tank 10. The sludge discharge unit 80 is provided to a part of the lower surface part 15 that corresponds to the tank part 10a positioned in the right-hand side of the illustration in FIG. 3. Additionally, the other UV monitors 70 are provided in the surface parts of the treatment tank 10 other than the lower surface part 15 (i.e., in the upper surface part 14 and the side surface parts 13a and 13b).

The UV monitors 70 are provided to monitor the dose of UV irradiation from the UV irradiation members 20. A plurality of (in the first embodiment, six) UV monitors 70 are provided so as to correspond to the respective six UV irradiation members 20 provided inside the treatment tank 10. These six UV monitors 70 are provided so as to linearly extend from the surface parts of the treatment tank 10 toward the respective UV irradiation members 20.

Specifically, as illustrated in FIG. 3, two UV monitors 70 of the six UV monitors 70 are provided in such a manner as to extend upward from the lower surface part 15 of the treatment tank 10 (the tank parts 10a), so as to correspond to two UV irradiation members 20 arranged in a lower inside region of the treatment tank 10, respectively. Other two UV monitors 70 of the six UV monitors 70 are provided in such a manner as to extend downward from the upper surface part 14 of the treatment tank 10, so as to correspond to two UV irradiation members 20 arranged in an upper inside region of the treatment tank 10, respectively. The remaining two UV monitors 70 of the six UV monitors 70 are provided in such a manner as to extend inward from the side surface parts 13a and 13b of the treatment tank 10₃ so as to correspond to two UV irradiation members 20 arranged in a vertically central inside region of the treatment tank 10, respectively.

UV sensors 71 that receive UV light (refer to arrowed chain lines in FIG. 3 and FIG. 4) from the UV irradiation members 20 and measure the dose of UV irradiation are provided on front ends of the respective six UV monitors 70 that face the UV irradiation members 20. The UV sensors 71 are provided so as to face UV irradiation surfaces of the respective corresponding UV irradiation members 20 (i.e., the outer circumferential surfaces of the protective tubes 22). Specifically, the respective UV sensors 71 are provided so as to face the central portions of the respective corresponding UV lamps 21. Furthermore, each of the UV sensors 71 is provided apart from the corresponding UV irradiation member 20 with a certain distance therebetween. Positions at which the respective UV sensors 71 are arranged are set, for example, so that the UV sensors 71 can obtain substantially the same measurement result of the dose of UV irradiation when there is no sludge S to be described later having accumulated inside (in a bottom part or on the lower surface part 15 of) the treatment tank 10.

Here, the sludge discharge unit 80 is provided in the lower surface part 15 of the treatment tank 10. Specifically, the sludge discharge unit 80 is connected to a discharge hole 81a provided at a position lower than a horizontal plane P1 (refer to two-dot chain lines in FIG. 3 and FIG. 4) that passes through UV light receiving surfaces (the upper surfaces) of the UV sensors 71 of the UV monitors 70 that are provided in the lower surface part 15 of the treatment tank 10. This discharge hole 81a is provided to discharge, to the outside of the treatment tank 10, sludge S such as mud that accumulates inside the treatment tank 10 when the treated water W passes through the inside of the treatment tank 10. The discharge hole 81a is provided at a position lower than a lower end 11a of the water supply opening 11 and lower than a lower end 12a of the water drainage opening 12. When the treated water W passes through the inside of the treatment tank 10 from the water supply opening 11 toward the water drainage opening 12, this structure can prevent flow of the treated water W from being hindered by a member (such as a cylindrical member 81 to be described later) configuring the discharge hole 81a.

As illustrated in FIG. 3 and FIG. 4, the sludge discharge unit 80 includes: the cylindrical member 81 that has an inner circumferential surface configuring the discharge hole 81a; and a valve 82 that blocks the discharge hole 81a in a manner that allows opening and closing of the discharge hole 81a. The cylindrical member 81 is provided so as to linearly extend downward from the lower surface part 15 of the treatment tank 10. The valve 82 is provided in the central portion of the cylindrical member 81 in the Z direction. The valve 82 is made of a manual valve, which is manually opened and closed by a user (such as a worker of a waterworks bureau). Here, the valve 82 is one example of a “valve member”.

As described above, in the first embodiment, the discharge hole 81a is provided at a position lower than the horizontal plane P1 passing through the UV light receiving surfaces of the UV sensors 71. Furthermore, the sludge discharge unit 80, which is used to discharge therethrough, to the outside of the treatment tank 10, the sludge S that accumulates in the bottom part of the treatment tank 10 when the treated water W passes through the inside of the treatment tank 10, is connected to this discharge hole 81a. This structure enables discharge of the sludge S through the sludge discharge unit 80 from inside the treatment tank 10, thereby it is possible to prevent the sludge S from accumulating between each of the UV sensors 71 provided in the lower surface part 15 of the treatment tank 10 and the UV irradiation member 20 corresponding to that UV sensor 71. Consequently, it is possible to prevent the sludge S from attaching to the UV light receiving surfaces of the UV sensors 71, thereby the accuracy of UV irradiation dose measurement performed by the UV sensors 71 can be thus kept from being impaired.

In particular, in a structure (what is called a different-diameter piping structure), such as the one in the first embodiment, in which the water supply opening 11 and the water drainage opening 12 provided to the treatment tank 10 have different inner diameters, the sludge S tends to accumulate inside the treatment tank 10 because the treated water W has a lower flow rate inside the treatment tank 10 and therefore stays longer than otherwise inside the treatment tank 10. Despite this structure, in the first embodiment, the sludge S can be discharged from inside the treatment tank 10 through the sludge discharge unit 80, thereby it is possible to effectively prevent the sludge S from accumulating between each of the UV sensors 71 and the corresponding UV irradiation member 20.

Meanwhile, the dose of UV irradiation from the UV irradiation members 20 is determined by feeding back readings of the UV monitors 70. For example, when readings of a specific one of the UV monitors 70 are small and unstable, it is determined that the dose of UV irradiation from the corresponding UV irradiation member 20 is insufficient, and the dose of UV irradiation from the UV irradiation member 20 is then controlled so as to be higher. However, even if it has been determined that the dose of UV irradiation from a specific one of the UV irradiation members 20 is insufficient, there may be a case where the dose of UV irradiation from the UV irradiation member 20 is actually sufficient. In this case, it is not needed to control the dose of UV irradiation from the UV irradiation member 20 so as to be higher.

In consideration of the possibility as described above, it is needed to increase the accuracy of UV irradiation dose measurement performed by the UV sensors 71 in order to avoid such a malfunction (erroneous control) of the UV irradiation apparatus 100 as to set the dose of UV irradiation from the UV irradiation members 20 unnecessarily high. For this reason, in the first embodiment, the sludge discharge unit 80 is provided to the treatment tank 10, so that the accuracy of UV irradiation dose measurement performed by the UV sensors 71 is kept from being impaired. According to the first embodiment, malfunctions of the UV irradiation apparatus 100 can be avoided.

### Modification of First Embodiment

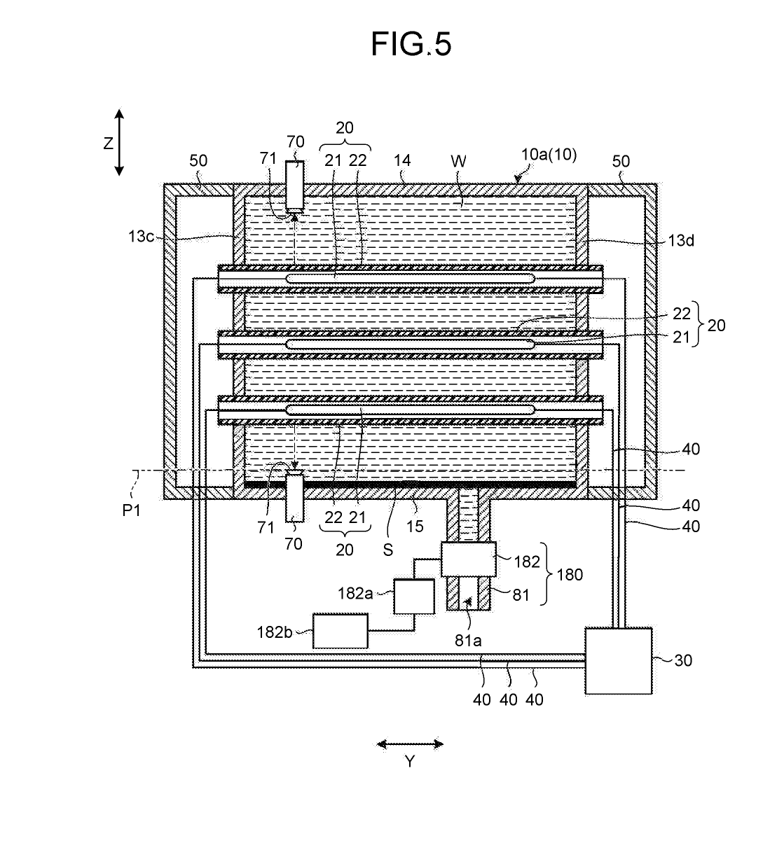

For the above-described first embodiment, an exemplary case is described in which the sludge discharge unit 80 is configured with the manual valve 82 that is manually opened and closed by a user (a worker of a waterworks bureau). However, as in the case of a modification illustrated in FIG. 5, a sludge discharge unit 180 can be alternatively configured with an electromagnetic valve 182 that automatically opens and closes the discharge hole 81a under the control of a controller 182b. The electromagnetic valve 182 is one example of the “valve member”.

In this modification, as illustrated in FIG. 5, a valve driver 182a including a motor that drives the electromagnetic valve 182 is connected to the electromagnetic valve 182. A controller 182b that controls the valve driver 182a is connected to the valve driver 182a. This controller 182b is configured to, for example, control the electromagnetic valve 182 to cause the valve driver 182a to regularly open and close the discharge hole 81a at certain time intervals. According to this structure, it is possible to regularly release the sludge S that has accumulated inside the treatment tank 10.

Alternatively, in the above modification, the electromagnetic valve 182 may be controlled to open and close the discharge hole 81a each time it is determined that the sludge S has accumulated inside the treatment tank 10. Here, the determination as to whether the sludge S has accumulated inside the treatment tank 10 can be made based on a result of comparison between results of UV irradiation dose measurement performed by the UV sensors 71 (referred to as first UV sensors hereinafter) of the UV monitors 70 that are provided in the bottom part (the lower surface part 15) of the treatment tank 10, around which the sludge S is relatively likely to accumulate, and results of UV irradiation dose measurement performed by the UV sensors 71 (referred to as second UV sensors hereinafter) of the UV monitors 70 that are provided in parts (the side surface parts 13a and 13b and the upper surface part 14) of the treatment tank 10 other than the bottom part, around which the sludge S is relatively likely not to accumulate.

That is, when any one of the dose of UV irradiation measured by the first UV sensors provided in the bottom part of the treatment tank 10 has become lower by a certain amount than any one of the dose of UV irradiation measured by the second UV sensors provided in the parts of the treatment tank 10 other than the bottom part, it can be determined that the sludge S has attached to the UV light receiving surface of the UV sensor as a result of accumulation of the sludge S in the bottom part of the treatment tank 10. Therefore, if a relationship between measurement results that would be obtained from each of the first UV sensors and from each of the second UV sensors when the sludge S has accumulated in the bottom part of the treatment tank 10 is previously stored, the controller 182b can control the valve driver 182a, based on the measurement results from the first UV sensors and the second UV sensors, so as to cause the electromagnetic valve 182 to open the discharge hole 81a when the sludge S has accumulated in the bottom part of the treatment tank 10. With controls of the controller 182b thus defined, the sludge S that has accumulated inside the treatment tank 10 can be discharged to the outside at appropriate timings.

### Second Embodiment

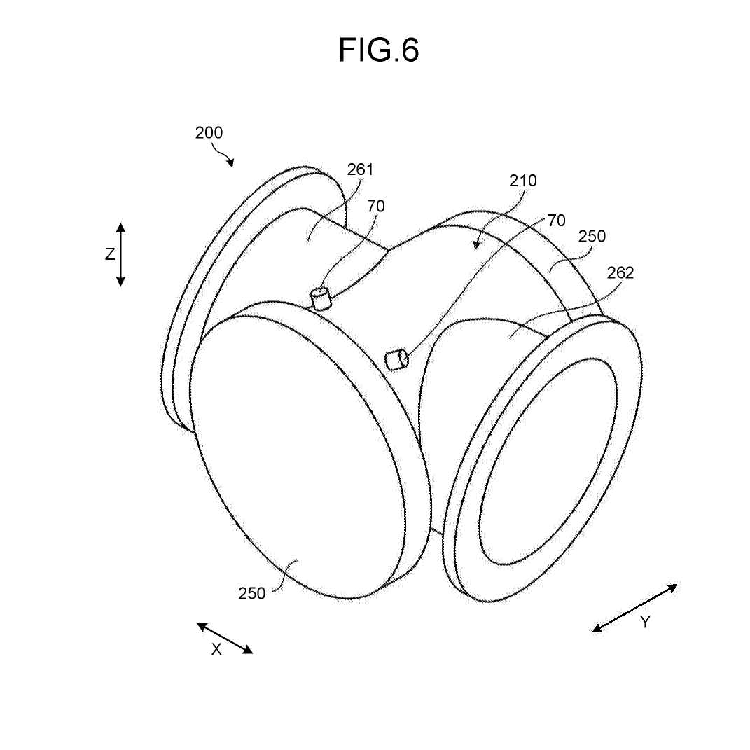

Next, an exemplary configuration of a UV irradiation apparatus 200 according to a second embodiment is described with reference to FIG. 6 to FIG. 8. In this second embodiment, which is different from the above-described first embodiment including the treatment tank 10 having a hollow rectangular parallelepiped shape (box shape), an exemplary case including a treatment tank 210 having a hollow columnar shape (cylindrical shape) is described.

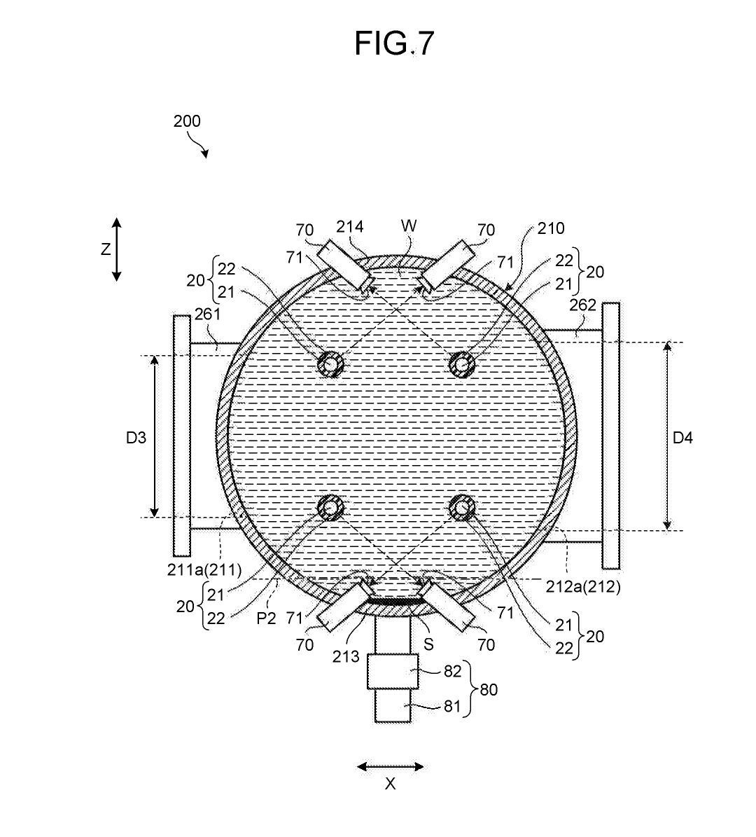

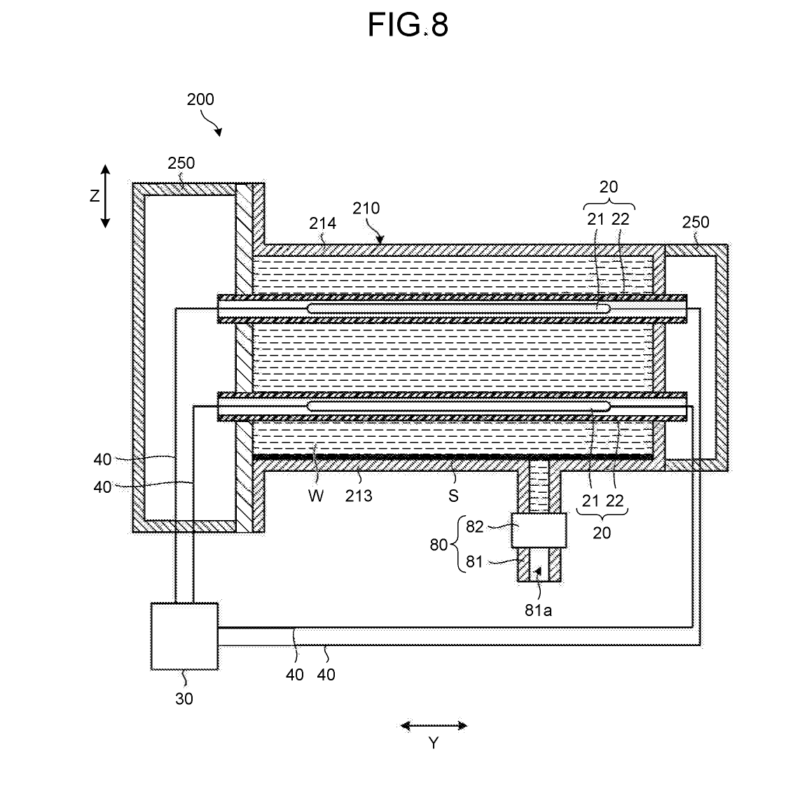

As illustrated in FIG. 6 to FIG. 8, the UV irradiation apparatus 200 according to the second embodiment includes the treatment tank 210 having a cylindrical shape extending in the Y direction, and a plurality of (in the second embodiment, four) UV irradiation members 20 extending in the Y direction. As illustrated in FIG. 6 and FIG. 8, covering members 250 having functions such as a light blocking function, an electric shock prevention function, an electromagnetic shield function, and a dew condensation prevention function are attached to the opposite ends in the Y direction of the treatment tank 210. FIG. 7 is a cross-sectional view of the UV irradiation apparatus 200 illustrated in FIG. 6, taken along an X-Z plane that passes through the UV monitors 70. FIG. 8 is another cross-sectional view of the UV irradiation apparatus 200 illustrated in FIG. 6, taken along a Y-Z plane that passes through the sludge discharge unit 80 (not illustrated in FIG. 5).

As illustrated in FIG. 7, a water supply opening 211 (with an inner diameter of D3) and a water drainage opening 212 (with an inner diameter of D4), which have different inner diameters, are provided in respective parts (side parts) of the treatment tank 210 that face each other in the X direction. A water supply port 261 and a water drainage port 262 in cylindrical shapes linearly extending in the X direction are connected to the water supply opening 211 and the water drainage opening 212, respectively.

The UV irradiation members 20 are arranged apart from one another. Specifically, as illustrated in FIG. 7, UV irradiation members 20 are provided in pairs positioned in the upper region and the lower region, respectively, of the inside of the treatment tank 210. The UV irradiation members 20 thus provided in each pair are arranged apart from each other in the X direction.

Here, in the second embodiment, a bottom part 213 (around which the sludge S is relatively likely to accumulate) of the treatment tank 210 has UV monitors 70 and a sludge discharge unit 80. While some of the UV monitors 70 are provided in the bottom part 213 of the treatment tank 210, the other of them are provided in a top part 214 (around which the sludge S is relatively likely not to accumulate) of the treatment tank 210.

As the UV monitors 70, a plurality of (in the second embodiment, four) UV monitors 70 are provided so as to correspond to the respective UV irradiation members 20 provided inside the treatment tank 210. Specifically, as illustrated in FIG. 7, the two UV monitors 70 provided in the bottom part 213 of the treatment tank 210 are provided so as to correspond to the two UV irradiation members 20 that are arranged in a lower inside region of the treatment tank 210. The other two UV monitors 70 provided in the top part 214 of the treatment tank 210 are provided so as to correspond to the two UV irradiation members 20 that are arranged in an upper inside region of the treatment tank 210. The two UV monitors 70 provided in the bottom part 213 of the treatment tank 210 are provided so as to extend in directions crossing each other. Likewise, the two UV monitors 70 provided in the top part 214 of the treatment tank 210 are also provided so as to extend in directions crossing each other.

Specifically, the UV monitor 70 positioned in the lower right-hand side in FIG. 7 is provided so as to face the UV irradiation member 20 provided in the lower left-hand side in FIG. 7 and to extend leftward and upward from the bottom part 213 of the treatment tank 210. The UV monitor 70 positioned in the lower left-hand stde in FIG. 7 is provided so as to face the UV irradiation member 20 provided in the lower right-hand side in FIG. 7 and to extend rightward and upward from the bottom part 213 of the treatment tank 210. The UV monitor 70 positioned in the upper right-hand side in FIG. 7 is provided so as to face the UV irradiation member 20 provided in the upper left-hand side in FIG. 7 and to extend leftward and downward from the top part 214 of the treatment tank 210. The UV monitor 70 positioned in the upper left-hand side in FIG. 7 is provided so as to face the UV irradiation member 20 provided in the upper right-hand side in FIG. 7 and to extend rightward and downward from the top part 214 of the treatment tank 210.

Also in the second embodiment, as in the case of the first embodiment, the discharge hole 81a (refer to FIG. 8) to which the sludge discharge unit 80 is connected is provided at a position lower than a horizontal plane P2 (refer to a two-dot chain line in FIG. 7) that passes through the UV light receiving surfaces (upper ends) of the UV sensors 71 of the UV monitors 70 provided in the bottom part 213 of the treatment tank 210. The discharge hole 81a is provided at a position lower than a lower end 211a of the water supply opening 211 and lower than a lower end 212a of the water drainage opening 212.

As described above, also in the second embodiment, as in the case of the first embodiment, the discharge hole 81a is provided at a position lower than the horizontal plane P2 passing through the UV light receiving surfaces of the UV sensors 71. Furthermore, the sludge discharge unit 80, which is used to release therethrough, to the outside of the treatment tank 210, the sludge S that accumulates in the bottom part of the treatment tank 210 when the treated water W passes through the inside of the treatment tank 210, is connected to this discharge hole 81a. Thus, also in the second embodiment, it is possible to prevent the sludge S from accumulating between each of the UV sensors 71 provided in the bottom part 213 of the treatment tank 210 and the UV irradiation member 20 corresponding to that UV sensor 71, thereby it is possible to keep the accuracy of UV irradiation dose measurement performed by the UV sensors 71 from being impaired.

While certain embodiments of the present invention have been described, these embodiments have been presented by way of example only, and are not intended to limit the scope of the invention. These embodiments may be implemented in a variety of other forms, and various omissions, substitutions, and changes may be made without departing from the spirit of the invention. The accompanying claims and their equivalents are intended to cover such omissions, substitutions, and changes as would fall within the scope and spirit of the invention.

The above embodiments can be implemented with the shape and the number of any constituent element therein changed as appropriate. That is, although the exemplary case in which the treatment tank is formed in a box shape or a cylindrical shape is described in each of the above embodiments and modification, the treatment tank may be formed in a shape that is neither a box shape nor a cylindrical shape. Furthermore, although exemplary cases in which the sludge discharge unit includes a cylindrical member and a valve member are described in the above embodiments, the sludge discharge unit may have a structure other than the above ones as long as the sludge discharge unit is capable of discharging therethrough the sludge accumulating in the bottom part of the treatment tank.

Furthermore, although an exemplary case in which the numbers of UV irradiation members and UV monitors are six or four is described in each of the above embodiments and modification, the numbers of UV irradiation members and UV monitors may be seven or more, five, or three or less. Furthermore, the numbers of UV irradiation members and UV monitors may not necessarily be the same. Furthermore, although an exemplary case in which the number of sludge discharge units is one is described in each of the above embodiments and modification, the number of sludge discharge units may be two or more.

1. An ultraviolet (UV) irradiation apparatus comprising:
a treatment tank that comprises a water supply opening to supply therethrough treated water to be further treated and a water drainage opening to drain therethrough the treated water;
a UV irradiation member that is provided inside the treatment tank and irradiates the treated water with UV light when the treated water passes through inside of the treatment tank;
a UV sensor that is provided inside the treatment tank and measures a dose of UV irradiation from the UV irradiation member; and
a sludge discharge unit that is connected to a discharge hole provided at a position lower than a horizontal plane passing through the UV sensor and that is provided to discharge, to outside of the treatment tank, through the discharge hole, sludge that accumulates inside the treatment tank when the treated water passes through the inside of the treatment tank.

2. The UV irradiation apparatus according to claim 1, wherein
the water supply opening and the water drainage opening have different inner diameters and are provided at positions horizontally facing each other, and
the discharge hole is provided at a position lower than a lower end of the water supply opening and lower than a lower end of the water drainage opening.

3. The UV irradiation apparatus according to claim 1, wherein the sludge discharge unit comprises:
a cylindrical member that comprises an inner circumferential surface configuring the discharge hole; and
a valve member that blocks the discharge hole in a manner that allows opening and closing of the discharge hole.

4. The UV irradiation apparatus according to claim 3, further comprising:
a valve driver that drives the valve member; and
a controller that controls the valve driver to cause the valve member to regularly open and close the discharge hole.

5. The UV irradiation apparatus according to claim 3, wherein
the UV sensor comprises:
a first UV sensor that is provided in a bottom part of the treatment tank, around which the sludge is relatively likely to accumulate; and
a second UV sensor that is provided in a part of the treatment tank other than the bottom part, around which the sludge is relatively likely not to accumulate, and
the UV irradiation apparatus further comprises:
a valve driver that drives the valve member; and
a controller that previously stores a relationship between measurement results of the dose of UV irradiation from the first UV sensor and measurement results of the dose of UV irradiation from the second UV sensor when the sludge has accumulated in the bottom part, and that controls the valve driver, based on the measurement results of the doses of UV irradiation from the first UV sensor and the second UV sensor, to cause the valve member to open the discharge hole when the sludge has accumulated in the bottom part.
